(19) United States
(12) Patent Application Publication
(10) Pub. No.: US 2009/0007364 A1
(43) Pub. Date: Jan. 8, 2009

(54) Connector Connecting a Windscreen-Wiper Blade to a Drive Arm

(75) Inventors: Jean-Michel Jarasson, Elancourt (FR); Gerald Caillot, Le Mesnil Saint Denis (FR); Guisseppe Grasso, Le Breuil Sur Couze (FR); Olivier Ruat, Saint Babel (FR); Frederic Boussicot, Conflans Ste Honorine (FR)

Correspondence Address: OSHA LIANG L.L.P., TWO HOUSTON CENTER, 909 FANNIN, SUITE 3500, HOUSTON, TX, 77010, US

(73) Assignee: VALEO SYSTÈMES D'ESSUYAGE, Le Mesnil-Saint-Denis (FR)

(21) Appl. No.: 11/912,855

(22) PCT Filed: Apr. 24, 2006
(86) PCT No.: PCT/EP06/61792

§ 371 Date: May 12, 2008

(30) Foreign Application Priority Data
Apr. 29, 2005 (FR) 0504406

(51) Int. Cl. B60S 1/40

(52) U.S. Cl. 15/250.32

(57) ABSTRACT

A connection device between a windscreen-wiper blade and a drive arm capable of powering wiping of said windscreen-wiper blade on a window or windscreen includes two flanges capable of being solidly attached to one another. The two flanges are fixed to the same axis of rotation according to two distinct positions in relation to at least one of the two flanges, or one of the two flanges includes a fixed axis of rotation.

### BACKGROUND OF INVENTION

1. Field of the Invention

The present invention relates to a connector connecting a windscreen-wiper blade to a drive arm.

2. Background Art

Windscreen-wiper alms, in particular of motor vehicles, generally consist of a mobile drive ann capable of moving a windscreen-wiper blade comprising a wiping strip pinned against a window or a windscreen.

For this reason, linking elements or connectors are required between the wiper blade and the drive arm.

It is known, according to the prior art, to manufacture connectors in the form of two parts capable of adjusting to and fixing on the windscreen-wiper blade due to the existence of means for attachment on the connectors inserted in complementary attachment means present on said windscreen-wiper blade.

The connectors firmly hold the windscreen-wiper blade during the wiping operation with substantially even pressure on a wiping strip whose free end rests directly against the window or windscreen.

In addition, in the standard manner, two types of connectors exist for connecting a drive arm to the wiper blade, and more precisely a drive arm to a support frame on which the wiping strip is fixed: either a connector with a so-called “side-lock” link or a connector with a so-called “top-lock” link.

A side-lock link is a link in which the drive arm is connected to the connector by an axis of rotation protruding from a lateral wall of the connector.

A top-lock link is a link in which the driver arm is connected to the connector by an axis of rotation passing through the two walls of the connector to enable axial connection of the driver arm by covering the connector.

Thus, in a side-lock link, the axis of rotation has one free end and the drive arm is transversally offset from the windscreen-wiper blade, while in a top-lock link, the axis of rotation is placed directly below the top wall of the windscreen-wiper blade.

The problem with these types of links is that they require a specific connector for each type of link and therefore the production of specific parts.

It is known, according to FR 2845852, to produce connectors manufactured in two symmetrical identical parts, but these are relatively complex to manufacture, due to the presence of means for fixing one part to the other in the form of lugs capable of being inserted in orifices present on the other part, resulting in the risk of breakage or incorrect attachment.

Moreover, it is known according to the prior art to manufacture connectors consisting of two identical parts providing a base for side-lock and top-lock connections.

However, different elements are required to connect the connector with the wiper blade according to the type of link.

### SUMMARY OF INVENTION

The invention particularly aims to provide drive arm connectors on a windscreen-wiper blade using few simple parts, allowing side-lock and top-lock type links equally.

The present invention relates to a connection device between a windscreen-wiper blade and a drive arm capable of powering the wiping of said windscreen-wiper blade on a window or windscreen, said device being presented in the form of two flanges capable of being solidly attached to one another, characterised in that at least one of the two flanges has means for fixing the same axis of rotation in two distinct positions in relation to at least one of the two flanges in the form of an orifice in said at least one of the two flanges.

Said same axis of rotation is advantageously presented in the form of a cylindrical element, one of its ends being capable of being inserted in said means for fixing an axis of rotation according to two distinct positions in relation to at least one of said two flanges.

In order to stabilise the device according to the invention on the windscreen-wiper blade, said device has means for strengthening the link and locking the flanges on the central body of the windscreen-wiper blade, advantageously in the form of a transversal plate present on one of the flanges and capable of cooperating with another transversal plate present on the other one of the flanges.

In order to allow the locking of the device according to the invention on the windscreen-wiper blade, each of said two flanges comprises means for cooperation and solid attachment with the other one of said two flanges in the form of a combination of lugs and orifices capable of fitting into one another.

In a more specific manner, the device according to the invention enables a connection with a side-lock link and a connection with a top-lock link and one of the two flanges has a general L shape.

Alternatively, according to another embodiment, the present invention relates to a connection device between a windscreen-wiper blade and a drive arm capable of powering the wiping of said windscreen-wiper blade on a window or windscreen, said device being presented in the form of two flanges capable of being solidly attached to one another, characterised in that one of said two flanges comprises a fixed axis of rotation and is generally U-shaped in its cross-section.

The flange comprising a fixed axis of rotation is advantageously capable of being solidly attaching to the other flange by cooperation means in the form of a combination of lugs and orifices capable of cooperating with one another.

According to another embodiment of a connector according to the invention, the present invention relates to a connection device between a windscreen-wiper blade and a drive arm capable of powering the wiping of the windscreen-wiper arm on a window or a windscreen, the device being presented in the form of two flanges capable of being solidly attached to one another, characterised in that the flanges have means for crimping an axis of rotation protruding from one of the two flanges, the flanges consisting of a bottom collar and a top collar, the bottom collar having means for locking the flange on the windscreen-wiper blade, the top collar of one of the flanges being capable of being attached to the top collar of the other one of the flanges.

The crimping means advantageously consist of at least one orifice made in said flanges or, alternatively, of the two orifices of the flanges.

Moreover, in order to allow the attachment of the two flanges with one another, each of the two flanges comprises means for cooperation and solid attachment with the other one of the two flanges, in the form of a combination of lugs and orifices capable of becoming inserted in one another.

The connection device according to this embodiment advantageously allows a connection with a side-lock link.

According to a further alternative embodiment of a connector according to the invention, the present invention relates to a connection device between a windscreen-wiper blade and a drive ann capable of powering the wiping of the windscreen-wiper blade on a window or windscreen, the device being presented in the form of two identical flanges, characterised in that the two flanges are connected to one another by the same axis of rotation so that they are parallel to one another and so as to provide a free space on said axis of rotation, the two flanges being presented in the form of a vertical flank, an orifice being made in the flanges so as to allow the attachment of the axis of rotation, an adaptor being capable of being fixed on the free space provided on the axis of rotation.

The flanges advantageously include means for locking on the windscreen-wiper blade in the form of lugs capable of being inserted in orifices made in the central body of the windscreen-wiper blade, a pair of horizontal tabs protruding perpendicularly from the flange being provided, surrounding each of the lugs.

Material indentations are advantageously made in the central body of the windscreen-wiper blade with a shape that matches the horizontal tabs, the latter being capable of being inserted in the material indentations.

Additionally, the flanges have means for strengthening the link between said flanges in the form of a protruding plate placed perpendicular to the flange and arranged on the flange so that its bottom surface comes to a stop against the top horizontal wall of the central body of the windscreen-wiper blade when solidly attaching the two flanges on the central body.

Advantageously, the horizontal plate protruding from one of the flanges has means for solid attachment with the horizontal plate protruding from the other flange, said attachment means of one of the flanges being in the form of an orifice and a lug made on the free end of the protruding plate, the lug of one of the flanges being capable of being inserted in the orifice of the other one of the flanges when assembling the device on the windscreen-wiper blade.

Alternatively, the means for solid attachment of one of the flanges are presented in the form of a material indentation and a material overhang, the material overhang of one of the flanges being capable of being inserted in the material indentation of the other one of the flanges when assembling the device on the windscreen-wiper blade.

The connection device according to this embodiment advantageously allows a connection with a top-lock link.

According to a further alternative embodiment, the present invention relates to a connection device between a windscreen-wiper blade and a drive arm capable of powering the wiping of the windscreen-wiper blade on a window or windscreen, the device being presented in the form of two identical collars capable of being fixed to the windscreen-wiper blade, characterised in that the collars include means for sliding means for fixing an axis of rotation, the sliding means being presented in the form of at least one groove made on the top wall of the collar and the fixing means of an axis of rotation being presented in the form of at least one vertical wall.

Alternatively, the means for fixing an axis of rotation are presented in the form of a top collar comprising a horizontal wall and a vertical wall.

The vertical wall advantageously comprises an orifice in which the axis of rotation can be crimped; each collar has a longitudinal lateral groove as well as a recess allowing the formation of a median groove when assembling the two collars on the windscreen-wiper blade, as well as a dovetailed protruding element on its top wall.

The vertical wall advantageously has one end capable of being inserted by sliding in each of said at least one groove, the end of the vertical wall being presented in the form of a dovetail and having material indentations on its lateral walls.

In order to allow the locking of the vertical walls, the elements that form it can be compressed, the compressed material being capable of cooperating with the material indentations, the collars advantageously being made from Zamak.

The collars according to this embodiment advantageously allow the formation of a side-lock, top-lock or GEN2B link.

In an additional or alternative manner, one of the two collars has hooks that can become inserted in inner spaces provided on the other one of the two collars when assembling the two collars on the windscreen-wiper blade.

According to a further alternative embodiment, the present invention relates to a connection device between a windscreen-wiper blade and a drive arm capable of powering the wiping of the windscreen-wiper blade on a window or windscreen, the device comprising two identical collars capable of being fixed on the windscreen-wiper blade, characterised in that the collars are capable of cooperating in a removable manner with fixing means of an axis of rotation, the collars being presented in the form of one horizontal wall and one transversal wall, the fixing means of an axis of rotation being presented in the form of two identical plates consisting of one horizontal wall and one vertical wall.

The horizontal wall of the flange is advantageously capable of resting against and solidly attaching to the horizontal wall of the collars and the vertical wall of the flanges has an orifice suitable for crimping the axis of rotation.

In order to allow the formation of several types of links, the flanges can be fixed on the collars in two distinct positions and the device according to the invention allows the formation of a side-lock, top-lock or GEN2B link.

According to a last alternative embodiment, the present invention relates to a connection device between a windscreen-wiper blade and a drive arm capable of powering the wiping of the windscreen-wiper blade on a window or a windscreen, comprising means for fixing on a windscreen-wiper blade and fixing means of a drive arm, characterised in that the means for fixing on a windscreen-wiper blade and said fixing means of a drive arm are made from a single-piece structure, the means for fixing on the windscreen-wiper blade being presented in the general shape of a parallelepiped comprising one bottom wall, two lateral walls and two transversal walls, the fixing means of a drive arm comprising a fixed axis of rotation and being presented in the shape of a parallelepiped comprising two lateral walls connected to one another by the axis of rotation.

The two lateral walls are advantageously connected to one another by two material bridges and, in a more precise manner, the two lateral walls have bevelled edges connected by a first material bridge and are connected by a transversal bridge.

Advantageously, the means for fixing on the windscreen-wiper blade comprise means for hooking on the windscreen-wiper blade presented in the form of hooking tabs which protrude from the bottom wall and are deformable.

### BRIEF DESCRIPTION OF DRAWINGS

The present invention is described below with the help of merely illustrative examples that do not limit the scope of the present invention, and according to the appended illustrations, in which:

FIG. 1 shows a perspective view of the connection means between a hook arm and a windscreen-wiper blade according to the prior art;

FIGS. 2 and 3 show perspective views of a connector according to a first embodiment of the invention for a side-lock link, before and after assembly on a windscreen-wiper blade respectively;

FIGS. 4 and 5 show perspective views, before and after assembling a connector respectively, also according to the first embodiment of the invention, but for a top-lock link;

FIG. 6 shows a bottom perspective view before assembly of another embodiment of the locking means for the connector such as described in FIGS. 2 to 5;

FIG. 7 shows a perspective view before assembly of a second embodiment of a connector according to the invention for a side-lock link;

FIG. 8 is a front view of the connector according to FIG. 7;

FIG. 9 is a perspective view of the second embodiment of a connector according to the invention but for a top-lock link;

FIG. 10 is a perspective view of the connector of FIG. 9 assembled on the windscreen-wiper blade;

FIG. 11 is a perspective view of a third embodiment of a connector according to the invention for a side-lock link;

FIG. 12 is a perspective view during assembly of a fourth embodiment of a connector according to the invention for a side-lock link;

FIG. 13 is a perspective view, before assembly on the windscreen-wiper blade, of a fifth embodiment of a connector according to the invention for a top-lock link;

FIG. 14 is a perspective view of the fifth embodiment of the connector as described in FIG. 13, but after assembly on the windscreen-wiper blade;

FIGS. 15 and 16 are perspective views, before and after assembly on the windscreen-wiper blade respectively, of an alternative embodiment of the fifth embodiment of a connector according to the invention for a top-lock link;

FIG. 17 is a perspective view of another alternative embodiment of the fifth embodiment of the connector according to the invention for a top-lock link;

FIG. 18 is a diagrammatic perspective view of a sixth embodiment of a connector according to the invention made using two collars for a GEN2B link;

FIG. 19 is a diagrammatic partial view of the sixth embodiment of the connector before solid attachment of the two collars;

FIG. 20 is a diagrammatic perspective view of the sixth embodiment of a connector, but for a top-lock link;

FIG. 21 is a diagrammatic perspective view of an alternative embodiment of the connector such as described in FIG. 20;

FIG. 22 is a diagrammatic perspective view of an alternative embodiment of a connector according to the sixth embodiment of the invention, but for a side-lock link;

FIG. 23 is a diagrammatic perspective view of an alternative embodiment of a connector according to the sixth embodiment of the invention, but for a top-lock link;

FIGS. 24 and 25 are diagrammatic perspective views of an alternative embodiment of a connector according to the sixth embodiment of the invention, but for a GEN2B link;

FIG. 26 is a diagrammatic cross-section view of an alternative embodiment of the sixth embodiment of a connector according to the invention for a top-lock link;

FIG. 27 is a diagrammatic cross-section view of an alternative embodiment of the sixth embodiment of a connector according to the invention for a side-lock link;

FIG. 28 is a diagrammatic cross-section view of an alternative embodiment of the sixth embodiment of a connector according to the invention for a GEN2B link;

FIG. 29 is a perspective view of a seventh embodiment of a connector according to the invention, but for a side-lock link;

FIG. 30 is a bottom perspective view of the connector of FIG. 29 after assembly and attachment on the windscreen-wiper blade.

### DETAILED DESCRIPTION

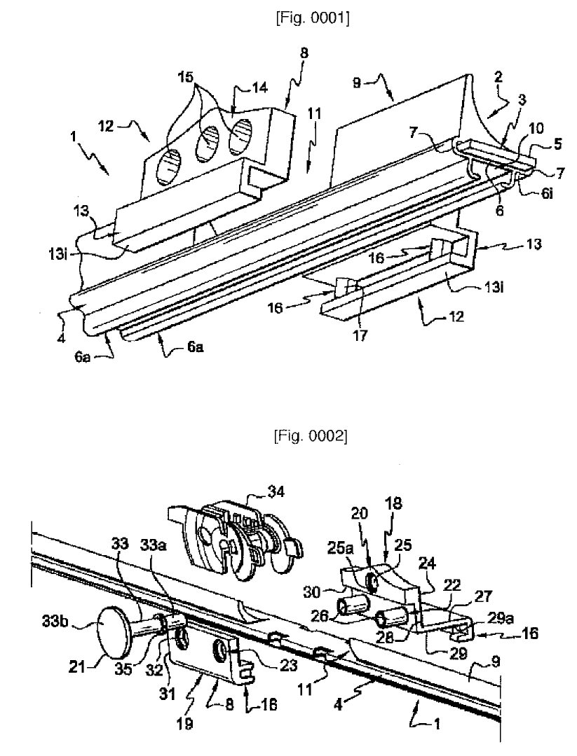

FIG. 1 shows a windscreen-wiper blade with reference number 1, advantageously of a known type, called flat blade, comprising a substantially longilinear support frame 2.

The support frame 2 consists of an inner spine 3 made up of a longitudinal horizontal blade inserted in a tubular central body 4 with a substantially longitudinal main axis delimited by a top horizontal wall 5, a horizontal bottom wall 6 and two vertical longitudinal lateral walls 7.

In the rest of the description, “longitudinal direction” is understood to mean the direction parallel to the longitudinal axis of the central body 4, “transversal direction” is a direction perpendicular to the longitudinal axis of the central body 4 and located in a plane that matches that of the inner spine 2, and “vertical direction” refers to a direction perpendicular to the longitudinal axis and to the plane defined by the inner spine 3.

Connection means 8 are provided for connecting the windscreen-wiper blade 1 to a drive arm (not shown in the figure but of a known type).

An upper rib 9 pointing vertically upwards is provided on the outer surface of the top wall 5 of the central body 4.

The upper rib 9 is advantageously formed such as to produce forces that pin the windscreen-wiper blade 1 against the surface of the window or windscreen, due to the relative action of the wind during the movement of the vehicle, thereby providing increased adherence of the wiping strip on the window or windscreen.

The bottom wall 6 of the central body 4 also includes hooking means for a wiping strip 13 in the form of a pair of opposing longitudinal hooks 6a pointing towards one another and forming an open inner space 10 in which the top of a wiping strip can be inserted.

The upper rib 9 has an indentation 11 in which the linking means or connector 8 are installed on the support frame 2.

The connector 8 is advantageously installed in the central part of the support frame 2 covering the top part 5 of the main body 4 as well as the two lateral walls 7.

According to the prior art, the connector 8 is made from two identical symmetrical parts 12 having a bottom collar 13 and a top collar 14, the bottom collar 13 having one bottom end 13i shaped like a hook capable of resting against and cooperating with the bottom surface 6i of the horizontal bottom wall 6 of the central body 4.

In addition, the top collar 14 has attachment means 15 capable of cooperating with the attachment means 15 of the other one of the two parts 12.

The bottom collar 13 has, in the inner space formed by the hook 13i, means 16 for locking the spine 3 in the form of lugs or teeth 17 capable of deforming the lateral walls 7 of the central body 4 and of being inserted in orifices made in the spine 3, not shown but having shapes that match the lugs or teeth 17 associated with the lateral wall 7 of the central body 4.

FIG. 2 shows a perspective view before assembly of a first embodiment of a connector according to the invention prior to assembly on the windscreen-wiper blade 1.

The connector 8, providing the connection between a windscreen-wiper blade 1 and a drive arm (not shown but of a known type), consists of a pair of flanges (18, 19) capable of cooperating with one another and of being solidly attached on the windscreen-wiper blade 1.

The pair of flanges (18, 19) advantageously consists of a primary flange or axis-supporting flange, hereinafter denoted 18, and a secondary flange 19.

The primary flange 18 has means for fixing 20 an axis of rotation 21 as well as means for solid attachment 22 with attachment means 23 having a matching shape on the secondary flange 19.

The primary flange 18 has a general L shape and consists of:
a top collar 24 having fixing means 20 for an axis of rotation 21 in the form of an orifice 25 as well as attachment means 22 in the form of a pair of lugs 26;
a bottom collar 27 comprising the means 16 for locking the inner spine 3 in the central body 4.

The top collar 24 is advantageously presented in the form of a vertical wall 28 and the bottom collar 27 in the form of a transversal wall 29 perpendicular to the vertical wall 28, with a hook-shaped end comprising the locking means 16.

The transversal wall 29 of the bottom collar 27 has substantially the same width as the transversal length of the central body 4.

The vertical wall 28 has, on its outer surface, which is to say on its surface opposite the surface on which the transversal wall rests 29, in addition to the pair of lugs 26 that form the attachment means 22, a material indentation 30 in which the vertical wall 31 of the secondary flange 19 can be completely or partially inserted.

The vertical wall 31 of the secondary flange 19 comprises means 23 for attachment with the attachment means 22 of the primary flange 18 in the form of a pair of orifices 32 with dimensions matching the size of the lugs 26 present on the outer surface of the vertical wall 28 of the primary flange 18.

FIG. 2 only shows two lugs 26, with a cylindrical shape, on the outer surface of the vertical wall 28, it being understood that at least one lug can be provided on the outer surface of the vertical wall 28 and that it is up to those skilled in the art to adapt the number of lugs on the vertical wall 28 of the primary flange 18 according to the number of orifices in the secondary flange 19.

Alternatively, it is possible to provide lugs on the secondary flange 19 capable of being inserted in orifices made in the vertical wall 28 of the primary axis-supporting flange 18. Likewise, a combination of lugs and orifices can be provided on each flange (18, 19), which are capable of cooperating with a combination of complementary lugs and orifices on the other flange (18, 19), so as to allow the solid attachment and connection of the two flanges (18, 19) to one another.

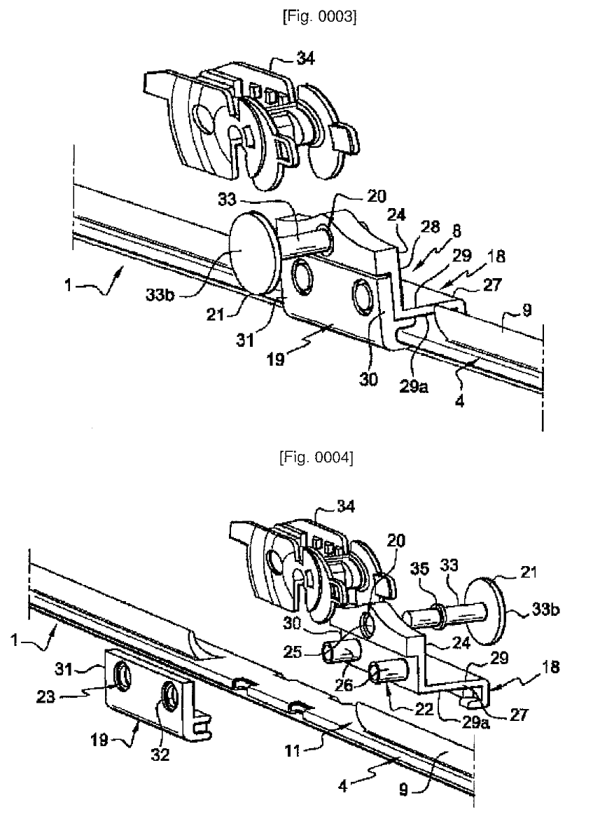

FIG. 3 shows a perspective view of the connector or of the connection means 8 according to the invention in an assembled position on the windscreen-wiper blade.

Also remarkable is the insertion of an axis of rotation 21 of a known type in the orifice 25 of the vertical wall 28 of the primary axis-supporting flange 18.

The axis of rotation 21 is presented in the form of a cylindrical element 33 on which it is possible to fix an adaptor 34 connected to a hook-type drive arm, of a known type and therefore not shown in the figures.

The substantially cylindrical element 33 has one end 33a capable of being inserted in the orifice 25, stopping means 33b located on the other end in the form of a circular plate placed transversally to the axis of rotation 21 and a ring 35 making it possible to lock the axis of rotation 21 in an internal indentation 25a of the orifice 25.

The ring 35 is advantageously arranged on the axis of rotation 21 at a distance that ensures that the length between the circular plate 33b and the ring 35 allows the adaptor 34 to be fixed on the axis of rotation 21 with no axial movement of the adaptor 34 on the cylindrical element 33 and therefore on the axis of rotation 21.

FIGS. 2 and 3 show side-lock connection means 8, which is to say having an axis of rotation 21 placed in a transversal direction and protruding from the outer surface of the vertical wall 28 of the primary flange 18 and with an insertion of the axis of rotation 21 at the level of the orifice 25 by the outer surface of the vertical wall 28 of the primary flange 18.

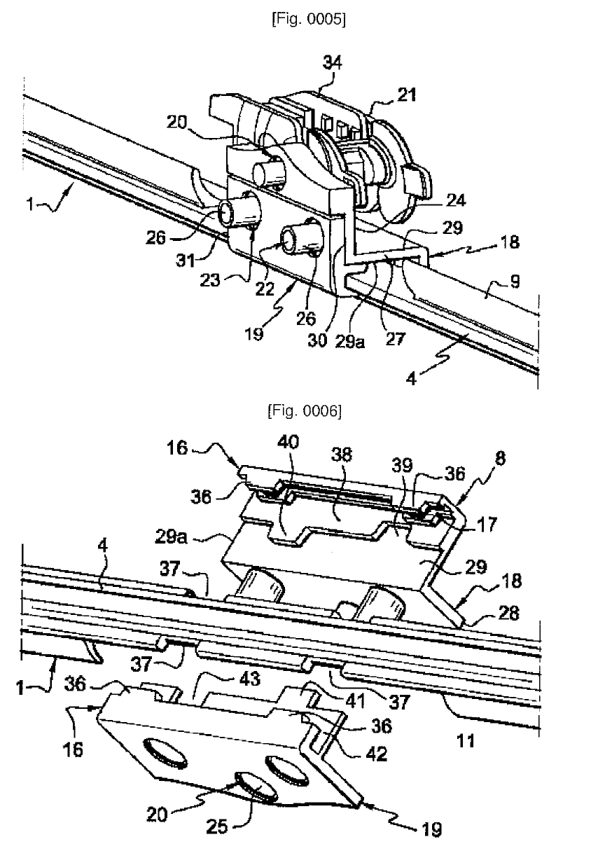

FIGS. 4 and 5 respectively show perspective views of connection means 8 having the same elements as the connection means according to FIGS. 2 and 3, but for a top-lock connection.

Unlike the embodiment according to FIGS. 2 and 3, which show a side-lock link, the axis of rotation 21 is inserted in the orifice 25 of the vertical wall 28 of the primary flange 18 at the level of its inner surface, which is to say the surface on which the transversal wall 29 of the primary flange 18 is resting.

In this way, the axis of rotation 21 is placed in the transversal direction directly above the transversal wall 29 of the primary flange 18.

The length between the ring 35 and the circular plate 33b of the cylindrical element 33 is substantially the same as the transversal height of the transversal wall 29.

The primary and secondary flanges (18, 19) are therefore made in this way, allowing the formation of a connector which can be a side-lock or top-lock link.

The orifice 25 therefore has means 20 for fixing an axis of rotation 21 allowing fixing and crimping of the axis of rotation 21 starting with insertion of the axis of rotation 21 equally from the outer surface or from the inner surface of the vertical wall 28 of the primary flange 18.

The orifice 25 consequently therefore comprises an inner indentation 25a on either side of the vertical wall 31 of the secondary flange 19, with a shape that matches the ring 35 of the axis of rotation 21 in order to allow locking and holding of the axis of rotation 21 according to two possible positions.

The primary or axis-supporting flange 18 therefore has means 20 for fixing an axis of rotation 21 according to two distinct positions, and consequently for the formation of a connector that can use a side-lock or a top-lock link equally.

The locking means 16 of each of the two flanges (18, 19) on the central body 4 of the windscreen-wiper blade 1 are presented in the form of a pair of lugs or teeth 17 surrounded vertically by two tabs 36 capable of respectively resting against the top horizontal wall 5 of the central body 4 and on the bottom wall 6 of the central body 4.

Each lug or tooth 17 is capable of being inserted and locked in an orifice 37 made in the central body 4.

Each central body 4 of the windscreen-wiper blade therefore comprises four orifices 37 capable of cooperating with the pairs of lugs or teeth 17 provided on the two flanges (18, 19).

FIG. 6 shows a bottom perspective view prior to assembly of another embodiment of the locking means 16 for a connector 8 such as described in FIGS. 2 to 5, which is to say for a link which can be of the side-lock type or the top-lock type equally.

The primary flange 18 has, on the outer surface 29a of its transversal wall 29, surface opposite the surface against which the vertical wall rests 28, a transversal plate 38 merged with the transversal wall 29 and having, on its end, a material indentation 29 and a material overhang 40, the material indentation 39 of the transversal plate 38 of the primary flange 18 being capable of cooperating with a material overhang 41 arranged on the free end of a transversal plate 42 placed above the lateral tabs 36 of the locking means 16 of the secondary flange 19.

The transversal plates (38, 42) of the primary and secondary flanges (18, 19) are advantageously capable of resting against the top wall 5 of the central body 4, when locking the flanges (18, 19) on the central body 4.

Moreover, the material overhang 40 of the primary flange 18 is capable of cooperating with a material indentation 43 made on the free end of the transversal plate 42 placed above the lateral tabs 36 of the locking means 16 of the secondary flange 19.

The material indentations (39, 43) are advantageously made in the shape of a slot.

Therefore, according to this embodiment of the invention, each flange (18, 19) has means (38, 42) for strengthening the link and locking the flanges (18, 19) on the central body 4 of the windscreen-wiper arm.

Additionally, the secondary flange 19 also has means 20 for fixing an axis of rotation 21 in the form of an orifice 25 on its top part in which it is possible to insert an axis of rotation 21 in the form of a cylindrical element 33.

In this way, the primary axis-supporting flange 18 does not have an internal material indentation 31 and the vertical wall 28 of the primary flange 18 is completely attached to the secondary wall when they are fixed on the central body 4.

The inner end 33a of the axis of rotation 21 is therefore capable of passing through the two orifices of the flanges (18, 19) during its insertion to form a link which can be of the side-lock type or of the top-lock type equally.

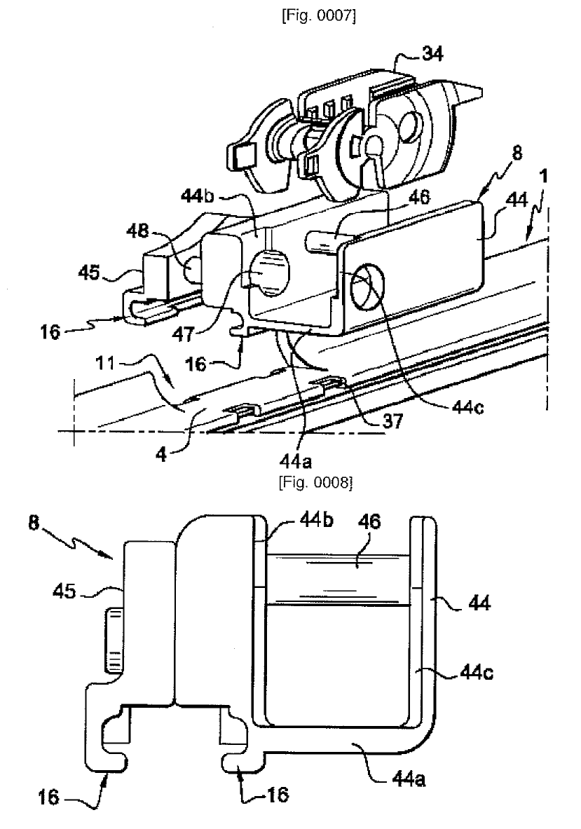

FIGS. 7 and 8 respectively show a perspective view and a cross-section view of another embodiment of a connector according to the invention for a side-lock link.

The connector 8 according to FIGS. 7 and 8 consists of an axis-supporting flange 44 and a secondary flange 45, the axis-supporting flange 44 having, in a cross-section view, a U shape with one bottom wall 44a and two lateral walls 44b and 44c.

In a more precise manner, the axis-supporting flange 44 comprises a first lateral wall 44b capable of being associated with and solidly attached to the secondary flange 45.

The lateral walls (44b, 44c) of the axis-supporting flange 44 are connected to one another by a fixed axis of rotation 46, with a generally cylindrical shape, advantageously made from the same material and the axis-supporting flange 44 and thus forming a cylindrical material bridge.

The axis-supporting flange 44 and the secondary flange 45 have locking means 16 with lugs 17 surrounded by lateral tabs 36, of the same type as described above in the other embodiments of the connector according to the invention.

Said first lateral wall 44b advantageously has locking means 16 on its bottom end.

In order to allow the solid attachment of the axis-supporting flange 44 with the secondary flange 45, the outer surface of said first lateral wall 44b is provided with at least one orifice 47 in which a lug 48 made on the surface of the secondary flange 45 can be inserted.

Alternatively, it is possible to make more than one orifice on the outer surface of said first lateral wall 44b of the axis-supporting flange 44 in which the same number of lugs provided on the secondary flange 45 can be inserted and cooperate.

In order to allow the attachment of the adaptor 34 on the axis of rotation 46 of the axis-supporting flange 44, the length of the axis of rotation 46 is substantially equal to the width of the adaptor 34.

The connector 8 such as described in FIGS. 7 and 8 advantageously allows a side-lock connection with the drive arm (not shown but of a known type).

The means 16 for locking the axis-supporting flange 44 located on a first lateral wall 44b are presented in the form of lateral tabs 36 surrounding the lugs 17, such as described previously, directed towards the outside, which is to say in a direction opposite the second lateral wall 44c and the bottom wall 44a, or a direction at a distance from the lateral walls (44b, 44c).

In this way, when solidly attaching the axis-supporting flange 44 and the secondary flange 45, an internal space is formed with a shape matching the shape of the central body 4 of the windscreen-wiper blade 1, with the bottom wall 44a of the axis-supporting flange 44 arranged laterally on the top wall 5 of the tubular central body 4.

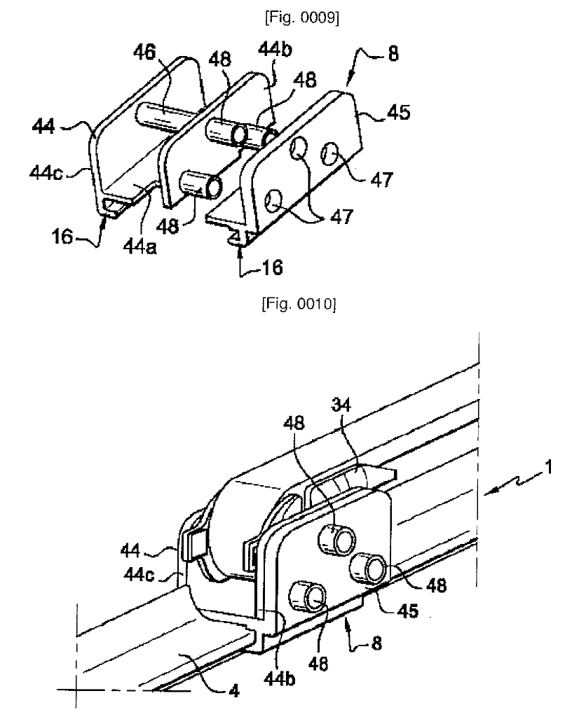

FIGS. 9 and 10 show perspective views of another embodiment of the connector according to another embodiment of the invention, before and after assembly on a windscreen-wiper blade respectively, but for a top-lock link.

The connector 8 according to FIGS. 9 and 10 also consists of an axis-supporting flange 44 and a secondary flange 45 but the locking means 16 are designed so that the connector 8 allows a top-lock link.

According to this embodiment, the means 16 for locking the axis-supporting flange 44 are presented in the form of a pair of tabs 36 located at the bottom end of one of the lateral walls (44b, 44c), the tabs 36 being directed towards the other one of the two lateral walls (44b, 44c), so that when fixing the axis-supporting flange 44 on the central body 4, the bottom wall 44a of the axis-supporting flange 44 is attached to and arranged on the top wall 5 of the central body 4.

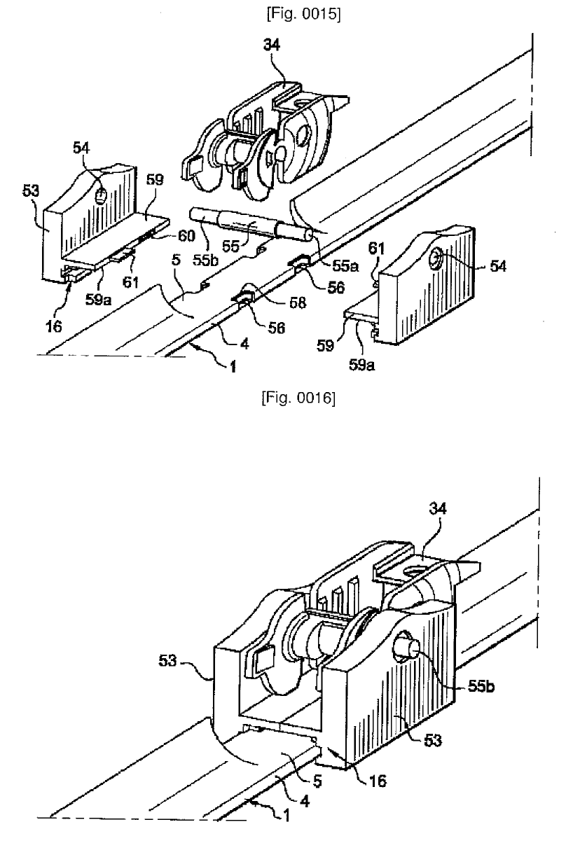

The secondary flange 45 is also presented in the form of a vertical wall with, on one of its ends, the locking means 16 as well as at least one orifice 47, and advantageously with three orifices as shown in FIGS. 14 and 15, capable of being inserted in lugs 48 made on the outer surface of the lateral wall 44c not having the locking means 16 on its bottom end.

Advantageously and in order to strengthen the solid attachment between the flanges (44, 45), the axis-supporting flange 44 has a bottom wall 44a with one end protruding from the lateral wall 44b having the lugs 47 on its surface and being capable of being inserted in an orifice made in the vertical wall of the secondary flange 45.

This embodiment of the invention also includes the formation of means (38, 42) for strengthening the link and locking the flanges (44, 45) on the central body 4, as described previously in FIG. 6.

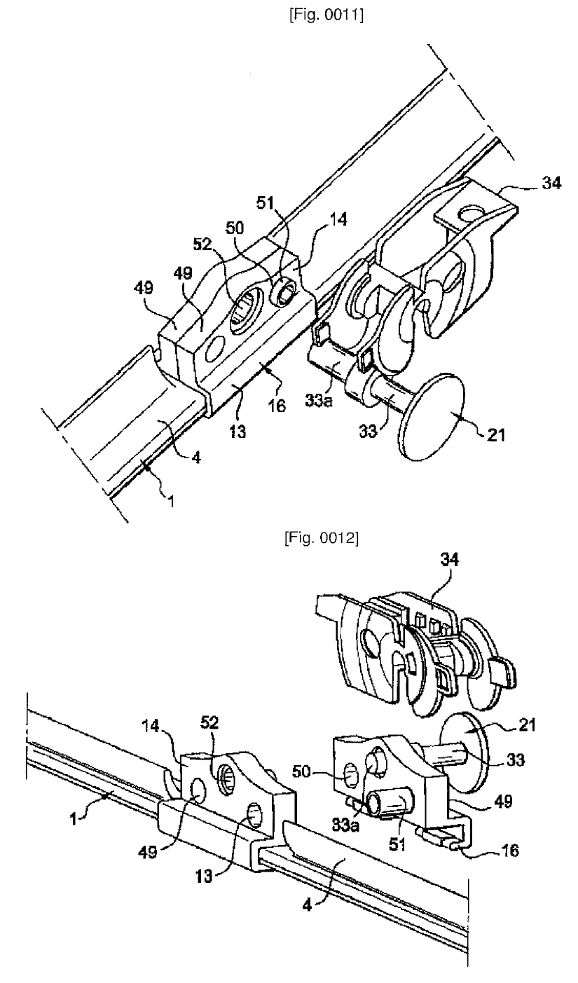

FIG. 11 is a perspective view of a third embodiment of a connector according to the invention for a side-lock link.

More precisely, the connector according to this embodiment consists of two identical flanges 49 each having locking means 16 with lugs 17 surrounded by lateral tabs 36 such as previously described.

Each flange 49 consists of a top collar 14 in the form of a flank and a bottom collar 13 including said locking means 16.

The top collar 14 of the flange 49 has attachment meant 15 capable of cooperating with the attachment means 15 of the other flange 49 when they are fixed on the central body 4 of the windscreen-wiper blade 1.

More precisely, each top collar 14 has one orifice 50 and one lug 51, the orifice of the top collar 14 of a flange 49 being capable of being inserted in a lug 51 of another flange 49 when assembling and fixing the two flanges 49 on a windscreen-wiper blade 1 in order to form the connector according to the invention.

Also provided in each flange 49, and more specifically in the flank of the top collar 14, is an orifice 52 in which an axis of rotation 21 in the form of a cylindrical element 33 is capable of being crimped and to which an adaptor 34, of a known type, is capable of attaching, connected to a hook-type drive arm.

In a more precise manner, the cylindrical element 33 has one end 33a capable of being inserted and passing through the two orifices 52 of the two flanges 49 when they are assembled on the windscreen-wiper blade 1.

The axis of rotation 21 is therefore crimped on the two identical flanges 49 assembled on the central body 4 of the windscreen-wiper blade 1.

FIG. 12 is a perspective view during assembly of a fourth embodiment of a connector according to the invention for a side-lock link.

According to this alternative embodiment, unlike in the third embodiment of the invention previously described in FIG. 11, the insertable end 33a of the cylindrical element 33 forming the axis of rotation 21 is only capable of being inserted in an orifice 52 of a flange 49 by crimping means of a known type.

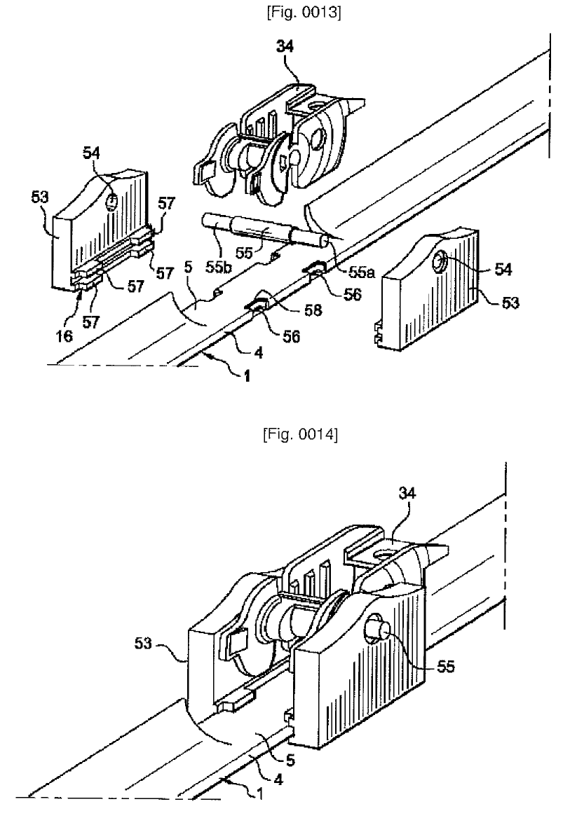

FIGS. 13 and 14 are perspective views, before and after assembly on the windscreen-wiper blade 1 respectively, of a fifth embodiment of a connector according to the invention for a top-lock link.

According to this fifth embodiment, a connector is formed from two flanges 53 made in the form of a vertical flank and having on one of their ends the locking means 16 such as previously described and, on the other end, an orifice 54 in which it is possible to insert the end of an axis of rotation 55 with a generally cylindrical shape.

The two ends (55a, 55b) of the substantially cylindrical axis of rotation 55 are both capable of being inserted in the orifice 54 of the two flanges 53 when assembling the two flanges 53 on the windscreen-wiper blade 1.

More precisely, the locking means 16 are made in the form of lugs or teeth 17 capable of being inserted in orifices 56 made in the lateral walls of the central body 4 of the windscreen-wiper blade 1.

Additionally, a pair of top and bottom horizontal tabs 57 protruding perpendicularly from the flange 53 is provided surrounding each lug or tooth 17.

Material indentations 58 are made in the central body of the windscreen-wiper blade 1 with a shape that matches these horizontal tabs 57, one material indentation 58 being made on the top wall 5 of the central body 4 and one material indentation 58 being made on the bottom wall 6 of the central body 4.

Thus, when fixing the flanges 53 on the windscreen-wiper blade, the user must insert the lugs or teeth 17 in the orifices 56, the protruding tabs 57 fitting into the material indentations 58 and thus providing better support and better holding of the vertical flanges 53 on the windscreen-wiper blade 1.

Furthermore, during the formation of this connector according to this fifth embodiment of the invention, the axis of rotation 55, after insertion in the orifices 53 of the flanges 53, forms a material bridge between the two flanges 53, thus making it possible further to increase the rigidity of the connector thus formed.

In this way, the two flanges 53 are linked to one another by a single axis of rotation 55 so as to be parallel to one another and to leave a free space on the axis of rotation 55, this free space allowing the attachment of an adaptor, of a known type, for solid attachment to a drive arm.

In this way, a connector with a top-lock link is formed, the adaptor 34 of a known type, being capable of fixing onto the axis of rotation 55 and being placed directly below the substantially longitudinal axis defined by the windscreen-wiper blade 1.

FIGS. 15 and 16 are perspective views, before and after assembly on the windscreen-wiper blade 1 respectively, of an alternative embodiment of the fifth embodiment of the connector according to the invention for a top-lock link.

According to this alternative embodiment, the flanges 53 have a protruding horizontal plate 59 located above the top horizontal protruding tab 57 capable of cooperating with the material indentation 58 made in the top wall 5 of the central body 4, said protruding horizontal plate 59 being arranged on the flange 53 so that its bottom surface 59a is in direct contact with and resting against the top horizontal wall 5 of the central body 4 when fixing the flanges 53 on this central body 4.

The protruding horizontal plate 59 has on its free end means for solid attachment with the other flange 53 in the form of an orifice 60 and a lug 61, so that the lug 61 of one of the flanges 53 is capable of being inserted in the orifice 60 of the other flange 53 during the formation and assembly of the two flanges 53 on the windscreen-wiper blade 1.

Thus, when mounting the flanges 53 on the blade 1, the link between the flanges 53 is strengthened using this protruding plate 59 and the support of said flanges 53 on the windscreen-wiper blade 1 is also improved.

FIG. 17 is a perspective view of another alternative embodiment of the fifth embodiment of the connector according to the invention for a top-lock link.

According to this alternative embodiment of the fifth embodiment of a connector according to the invention, the flanges 53 have means for reinforcing the link between the flanges 53 in the form of a protruding horizontal plate 59 placed above the protruding horizontal tab 57 capable of cooperating with the material indentation 58 made in the top wall 5 of the central body 4, said protruding horizontal plate 59 being arranged on the flange 53 so that its bottom surface 59a is in direct contact with and resting against the top horizontal wall 5 of the central body 4.

The protruding horizontal plate 59 has a material indentation 62 forming a slot as well as a material overhang 63 also forming a slot with dimensions matching the material indentation 62.

The material overhang 63 of one of the flanges 53 is advantageously capable of being inserted in the material indentation 62 of the other flange 62 during the formation and assembly of the flanges 53 on the windscreen-wiper blade, enabling the formation of a connector with a top-lock link.

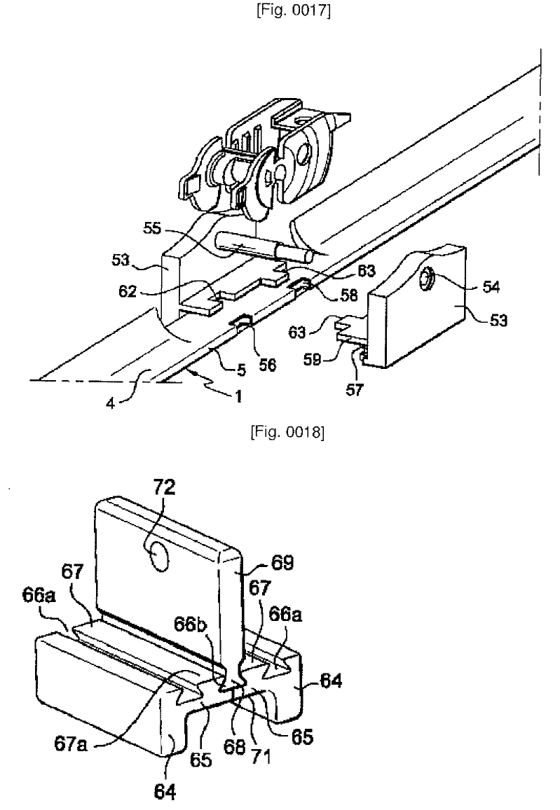

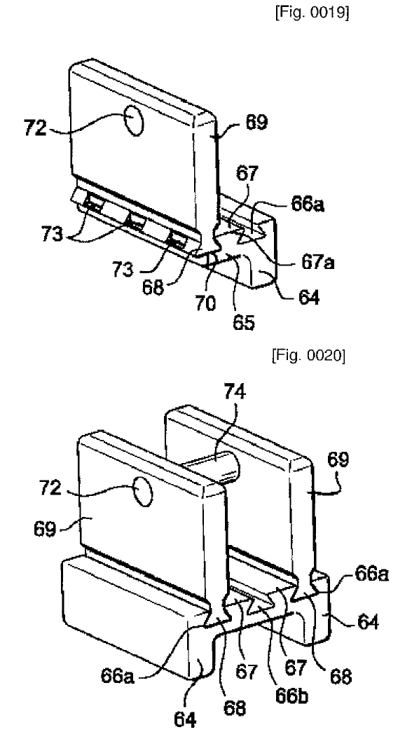

FIG. 18 is a diagrammatic perspective view of a sixth embodiment of a connector according to the invention, made up of two collars for a GEN2B link, and FIG. 19 is a diagrammatic partial view of the sixth embodiment of the connector before solidly attaching the two collars.

As can be seen in FIGS. 18 and 19, a connector linking a windscreen-wiper blade with a driver arm is only partially shown without the means 16 for locking on the central body 4 of the windscreen-wiper blade 1 and such as described previously.

The connector according to this embodiment consists of a pair of bottom collars 64 fixed using any type of means to the locking means 16 such as previously described but not shown in the figures for the purpose of clarity.

Each bottom collar 64 is L-shaped and is rotated in the clockwise direction by a 90° angle with a top horizontal wall 65 having at least one groove 66 called “lateral groove 66a” and a substantially trapezoidal dovetailed protruding element 67.

More precisely, the groove 66 defines an inner gap shaped like a truncated pyramid in which it is possible to insert a dovetailed end 68 of a removable vertical wall 69 by sliding.

The top horizontal wall 65 of the bottom collar 64 also has one free end forming a recess 70 allowing the formation of a median groove 66b when the recesses 70 made in the free end of each top horizontal wall 65 of the collar meet, and thus also defining an inner gap shaped like a truncated pyramid.

More precisely, when assembling the two collars 64 on the windscreen-wiper blade 1, a top support wall 71 is thus formed, made up of the two top walls 65 of the two collars 64 connected by their free ends and having three grooves 66, one median groove 66b and two lateral grooves 66a, substantially identical and delimited among each other by two dovetailed protruding elements 67 forming a truncated pyramid or a trapezium in a transversal cross-section view.

However, it is up to those skilled in the trade to manufacture top support walls 71 with more than three grooves 66 and more than two protruding elements 67.

An orifice 72 in which an axis of rotation, of a known type, can be crimped, is made in the vertical wall 69.

The dovetailed end 68 of the vertical wall 69 is advantageously inserted in the median groove 66b of the support wall 71, thus allowing the formation of a connector between a drive arm and a windscreen-wiper blade 1 for a so-called “GEN2B” link when crimping the axis of rotation 74 in the vertical wall 68 sliding in the median groove 66b.

Once the dovetailed end 68 of the vertical wall 69 is inserted in the median groove 66b, the protruding elements 67 are compressed by exerting a downward compression force on their top end 67a using any possible type of compression instrument.

Indeed, the collars 64 are advantageously made from a deformable semi-rigid material, for example Zamak.

Due to the presence of recesses 73 in the lateral walls of the dovetailed end 68 of the vertical wall 69, the compressed material resulting from the protruding elements 67 is forced into these recesses 73 allowing the vertical wall 69 to be locked in the median groove 66b.

Additionally, stoppers can be provided, of a known type, in the median groove 66b, in order to allow locking of the dovetailed end 68 of the vertical wall 69 when they are slid into the median groove 66b.

Alternatively, stopping means, for example in the form of hooks fixed between the protruding elements 67 located on either side of the median groove 66b of the two collars 64, can be fixed to make it possible to reinforce the locking of the vertical wall 69 on the two collars after compressing the protruding elements 67.

FIG. 20 is a diagrammatic perspective view of a sixth embodiment of a connector according to the invention, but for a top-lock link.

The connector as shown in FIG. 20 also consists of two bottom collars 64 connected to one another when they are locked and fixed using locking means 16 on the central body 4 of the windscreen-wiper blade 1.

However, according to this embodiment, the bottom collars 64 are associated with two vertical walls 69 and, more precisely, the dovetailed bottom end 69 of a first vertical wall 69 is slid into a first lateral groove 66a of a first bottom collar 64 and the dovetailed bottom end 68 of a second vertical wall 69 is also slid into the other lateral groove 66a of the second bottom collar 64, which is connected to the first collar 64 when assembling and locking the two collars 64 on the central body 4 of the windscreen-wiper blade 1.

An axis of rotation 74, of a known type, capable of being inserted in each orifice 72 of the vertical walls 69, is also provided in order to connect the two vertical walls 69 to one another, on which an adaptor of a known type can also be attached.

In this way, a connector between a drive arm and a windscreen-wiper blade 1 is formed allowing the formation of a top-lock link, the axis of rotation 74, crimped on the two vertical walls 69, being located directly below the support wall 71 of the connector.

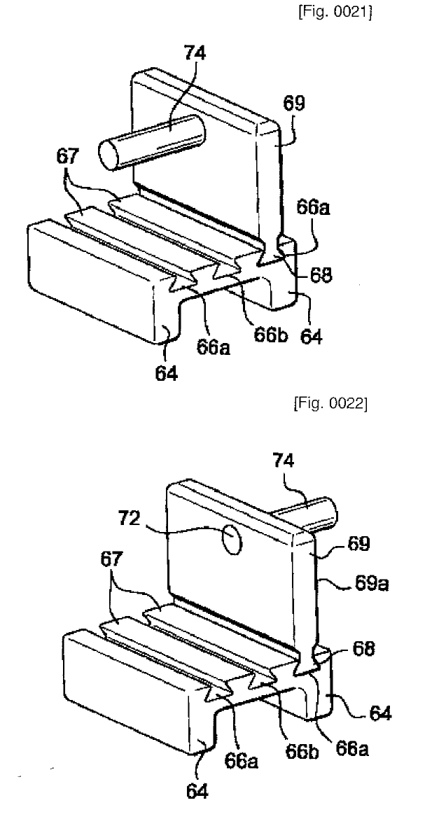

Alternatively and as shown in FIG. 21, it is possible to make a connector for a top-lock link using only a vertical wall 69 in which an axis of rotation 74 is crimped, the axis of rotation being located directly below the top wall 71 of the two bottom collars 64.

Alternatively and as shown in FIG. 22, it is possible to make a connector for a side-lock link using only a vertical wall 69 in which an axis of rotation 74 is crimped, the axis of rotation being crimped on the outer lateral wall 69a of the vertical wall 69.

It is well understood that the vertical walls 69 can be inserted in the lateral grooves 66a and locked by compression of the protruding elements 67 such as previously described, the dovetailed end 68 having material recesses 73 allowing compressed material to be placed in these recesses 73 during this compression.

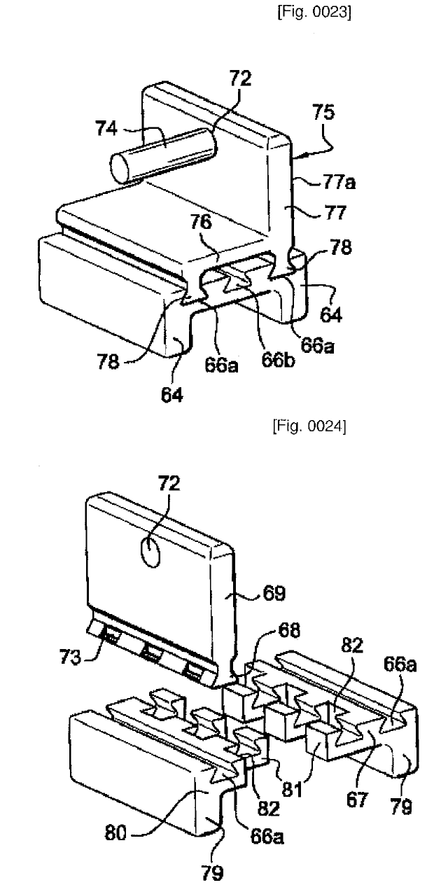

FIG. 23 is a diagrammatic perspective view of an alternative embodiment of a connector according to the sixth embodiment of the invention, but for a top-lock link.

According to this alternative embodiment, an L-shaped top collar 75 is provided which is capable of cooperating with the bottom collar 64 and comprises a horizontal wall 76 and a vertical wall 77, the horizontal wall advantageously having two dovetailed protruding elements 78 capable of fitting by insertion in the two lateral grooves 66a of the top wall 71 of the two collars 64.

The vertical wall 77 also comprises an orifice 72 in which an axis of rotation 74, of a known type, can be crimped allowing either the formation of a top-lock link and such as shown in FIG. 23, or the formation of a side-lock connector when crimping the axis of rotation 72 by the outer lateral surface 77a of the vertical wall 77 of the top collar 75.

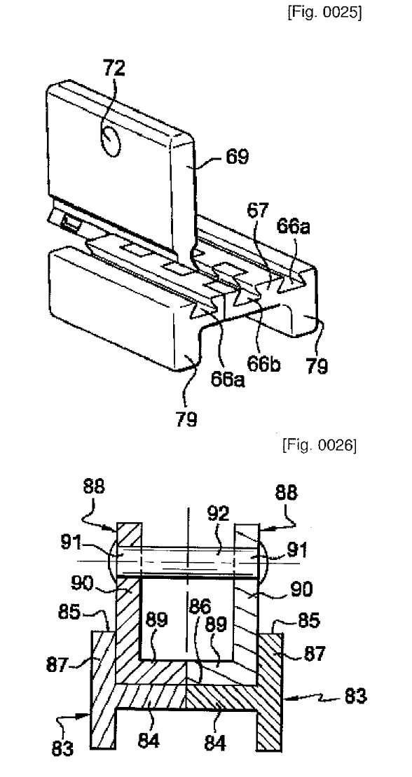

FIGS. 24 and 25 are diagrammatic perspective views of an alternative embodiment of a connector according to the sixth embodiment of the invention, but for a GEN2B link.

According to this embodiment depicted in FIGS. 24 and 25, a connector according to the invention is formed using two identical bottom collars 79 forming an L shape rotated by a 90° angle in the clockwise direction 80 having a lateral groove 66a shaped like a truncated pyramid and a protruding element 67.

The top horizontal wall 80 has, on its free end, hooks 81 that rest against the protruding element 67, the inner curve of which is shaped like a truncated pyramid, the curved end of each hook 81 being capable of being inserted in an inner space 82 made in the protruding element 67 of the other bottom collar 64.

When solidly attaching the two collars 64 on the central body 4 of the windscreen-wiper blade 1, the hooks 81 of one of the collars 64 are inserted in the inner spaces 82 of the other one of the collars so as to form a median groove 66b defining an dovetailed inner gap in which the bottom end 68 of a vertical wall 69 can slide.

FIG. 26 is a diagrammatic cross-section view of an alternative embodiment of the sixth embodiment of a connector according to the invention for a top-lock, side-lock and GEN2B link respectively.

According to this embodiment, the connectors consist of two bottom collars 83 arranged, in a cross-section view, in a general T shape rotated by an angle of 90° in the clockwise direction, comprising a horizontal wall 84 and a transversal wall 85, the bottom collars 83 being connected to one another by the free end of the horizontal wall 84.

The bottom collars 83 are connected to one another by any known connection means and are locked on the windscreen-wiper blade 1 with the help of locking means 16 such as previously described or using any type of means for fixing on a windscreen-wiper blade 1 of a known type.

Once the two bottom collars 83 are connected by the free end of the horizontal walls 84, a top cavity is thus formed, comprising a horizontal support wall 86 and two vertical lateral walls 87.

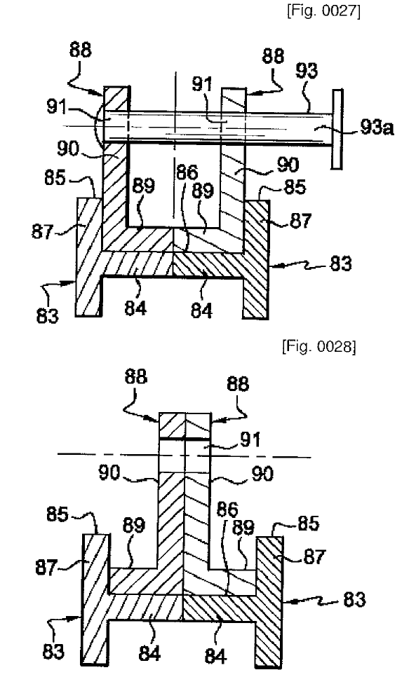

Two identical flanges 88, in a general L shape, and consisting of a horizontal wall 89 and a vertical wall 90 are capable of being solidly attached to the bottom collars 83 in order to form a connector according to the invention, either of the top-lock (FIG. 26), side-lock (FIG. 27) or GEN2B (FIG. 28) type.

According to a first linking method, the horizontal walls 89 of the flanges 88 are connected by their free end and attached to the top walls 84 of the collars 83 by any known type of link.

Each vertical wall 90 of the flanges 88 comprises an orifice 91 in which an axis of rotation 92 of a known type can be crimped.

In order to form a connector for a top-lock link, the axis of rotation 92 is made in the shape of a substantially cylindrical element with a length equivalent to twice that of the horizontal wall 89 of the flange 88.

In this case, the axis of rotation is generally directly below the horizontal walls 89 of the two flanges 83 and not made to open onto and protrude from one of the vertical walls 90 of the two flanges 88.

According to the embodiment depicted in FIG. 27, the axis of rotation 93 is made with one end protruding 93a from one of the vertical walls 90 of the two flanges 88, the flanges also being connected by the free ends of their horizontal wall 89 and resting against and being fixed onto the vertical walls 84 of the bottom collars 83.

According to this embodiment, the protruding end 93a of the axis of rotation 93 advantageously has a length that allows an adaptor 34 of a hook arm (not shown in FIG. 27 but of a known type) to be attached thereto.

According to the connector depicted in FIG. 28, two bottom collars 83 are also provided in a general T shape with two horizontal walls 84 connected by their free end and on which the horizontal walls 89 of the two flanges 88 are resting.

However, unlike the connectors such as previously described in FIGS. 26, 27, the flanges 88 are attached to one another by their vertical walls 90.

The vertical walls 90 of the flanges 88 therefore have a common central orifice 91 in which an axis of rotation of a known type can be crimped, allowing the formation of a connector according to the invention for a GEN2B link.

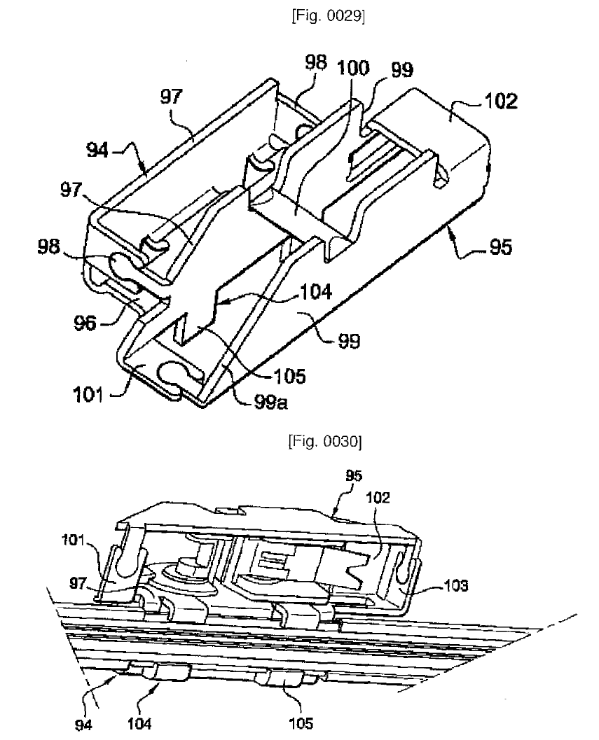

FIGS. 29 and 30 are perspective views of a seventh embodiment of a connector according to the invention, but for a side-lock link, before and after assembly on a windscreen-wiper blade respectively;

The connector according to a seventh embodiment of the invention for a side-lock link consists of means 84 for fixing on a windscreen-wiper blade of a known type, and advantageously a flat-blade type blade, as well as of fixing means 95 of a drive arm, of a known type, by means of an adaptor 34 of a known type.

The means 94 for fixing on the windscreen-wiper blade 1 are in the general shape of a parallelepiped with one bottom wall 96, two lateral walls 97 and two transversal walls 98.

The fixing means 95 of a drive arm are also in the general shape of a parallelepiped with two lateral walls 99 having a bevelled edge 99a, a substantially cylindrical fixed axis of rotation 100 connecting the two lateral walls 99 and two material bridges 101, 102, a first material bridge 101 connecting the bevelled edges 99a of the lateral walls and a second material bridge 102 connecting the lateral walls to the other end of the lateral walls 99, the material bridges (101, 102) being substantially parallel in relation to one another and substantially horizontal.

In addition, a transversal wall 103 is also provided between the two lateral walls 99.

Advantageously, the connector according to this embodiment consists of means 94 for fixing on the windscreen-wiper blade 1 and fixing means 95 of a drive arm and is made from a single-piece structure, which is to say that it is made by cutting and folding a sheet of Zamak, for example.

In addition, one of the lateral walls 97 of the means for fixing on the windscreen-wiper blade 94 is substantially merged with one of the lateral walls 99 of the fixing means of an axis of rotation 95.

Furthermore, at the height of the link between the bottom wall 96 and the lateral walls 97 of the means for fixing on the windscreen-wiper blade 94, hooking means are provided 104 on the windscreen-wiper blade in the form of hooking tabs 105 shaped like parallelepipedal elements protruding from the plane defined by the bottom wall 96.

Since the connector is made from a semi-rigid material, and advantageously from Zamak, the hooking tabs 105 are deformable and, more precisely, can be folded so that when fixing the connector according to this embodiment on a windscreen-wiper blade, the bottom wall 96 of the means for fixing on a windscreen-wiper blade 94 are attached to the top wall 5 of the central body 4 of the windscreen-wiper blade 1 and the hooking tabs 105 are located to the sides of this central body 4 and are capable of being folded so that their end is resting against the bottom wall 6 of the central body 4 of the windscreen-wiper blade 1.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A connection device between a windscreen-wiper blade and a drive arm capable of powering wiping of said windscreen-wiper blade on a window or windscreen, said connection device comprising;
two flanges capable of being solidly attached to one another,
wherein at least one of the two flanges has means for fixing the same axis of rotation according to two distinct positions in relation to at least one of the two flanges.

2. The connection device according to claim 1, wherein said means for fixing the same axis of rotation according to two distinct positions comprises an orifice in at least one of said two flanges.

3. The connection device according to claim 1, wherein said same axis of rotation comprises a cylindrical element, having one end capable of being inserted in said means for fixing the same axis of rotation according to two distinct positions in relation to at least one of said two flanges.

4. The connection device according to claim 1, further comprising means for strengthening a link and locking of the flanges on a central body of the windscreen-wiper blade.

5. The connection device according to claim 4, wherein said means for strengthening the link and locking of the flanges comprises a transversal plate present on one of the flanges and capable of cooperating with another transversal plate present on the other one of the flanges.

6. The connection device according to claim 1, wherein each of said two flanges comprises means for cooperation and solid attachment with the other one of said two flanges in the form of a combination of lugs and orifices capable of fitting into one another.

7. The connection device according to claim 1, wherein the connection device allows a connection with a side-lock link and a connection with a top-lock link.

8. The connection device according to claim 1, wherein one of the two flanges has a general L shape.

9. A connection device between a windscreen-wiper blade and a drive arm capable of powering wiping of said windscreen-wiper blade on a window or windscreen, said connection device comprising:
two flanges capable of being solidly attached to one another,
wherein one of said two flanges comprises a fixed axis of rotation.

10. The connection device according to claim 9, wherein said flange comprising a fixed axis of rotation has a U shape in a transversal cross-section, with one bottom wall and two lateral walls.

11. The connection device according to claim 10, wherein said flange comprising a fixed axis of rotation has a so-called first lateral wall capable of being associated with and solidly attached to the other flange.

12. The connection device according to claim 9, wherein said flange comprising a fixed axis of rotation is capable of being solidly attached to the other flange by a combination of lugs and orifices capable of cooperating with one another.

13. The connection device according to claim 9, wherein said flanges comprise means for locking on said windscreen-wiper blade.

14. The connection device according to claim 13, wherein said locking means comprises lugs surrounded by lateral tabs, said lugs being capable of being inserted in orifices made in a central body of said windscreen-wiper blade.

15. The connection device according to claim 9, wherein the connection device allows a connection with a side-lock link.

16. The connection device according to claim 9, wherein the connection device allows a connection with a top-lock link.

17. The connection device of claim 1, wherein said flanges comprise means for crimping an axis of rotation protruding from one of the two flanges.

18. The connection device according to claim 1, wherein said flanges comprise a bottom collar and a top collar.

19. The connection device according to claim 18, wherein said bottom collar comprises means for locking said flange on said windscreen-wiper blade.

20. The connection device according to claim 18, wherein said top collar of one of the flanges is capable of being associated with said top collar of the other one of the flanges.

21. The connection device according to claim 17, wherein said crimping means comprises at least one orifice made in said flanges.

22. The connection device according to claim 17, wherein said crimping means consist of the two orifices of said flanges.

23. The connection device according to claim 17, wherein each of said two flanges comprises means for cooperation and solid attachment with the other one of said two flanges in the form of a combination of lugs and orifices capable of fitting into one another.

24. The connection device according to claim 17, wherein the connection device allows a connection with a side-lock link.

25-75. (canceled)
